(19) United States
(12) Patent Application Publication
(10) Pub. No.: US 2014/0360333 A1
(43) Pub. Date: Dec. 11, 2014

(54) HARD-METALCUTTING BLADE ARRANGEMENT FOR CHUCKING IN A ROUND RECEIVER

(71) Applicant: TIGRA GMBH, Oberndorf am Lech (DE)

(72) Inventors: Eduard Sprow, Erolzheim (DE); Thomas Sprow, Donauwoerth/Zirgesheim (DE)

(73) Assignee: TIGRA GMBH, Oberndorf am Lech (DE)

(21) Appl. No.: 13/915,611

(22) Filed: Jun. 11, 2013

(51) Int. Cl. B26D 7/26; B26D 1/00

(52) U.S. Cl. CPC B26D 7/2614; B26D 1/0006; B26D 2001/004
USPC 83/698.11

(57) ABSTRACT

In a hard metal cutting blade arrangement with blade installation in a cylindrical chucking block for cutting sheets of materials, comprising a cutting blade of a hard metal in the form of an elongate plate body with a blade ground onto a front area thereof and a rear area forming a plate-like shaft, a cylindrical metal chucking block is provided through which an axial slot extends diametrically almost over the whole diameter with a slot width corresponding to the thickness of the shaft of the cutting blade and the cylindrical surface of the chucking block is cut back radially at both sides of the slot over the length of the chucking block.

### BACKGROUND OF THE INVENTION

The invention resides in a hard-metal cutting blade arrangement for technical cutting arrangements for chucking a flat cutting blade in a round receiver.

Sheets of paper, cardboard, plastic foils or textile materials as well as large parts such cardboards for folding boxes or material cutouts for pieces of clothing are usually cut by stamping. However, since most large stamping tools are very expensive, the stamping procedure is economical only for large series production. In small series production, it is more economical to cut the parts by cutting arrangements which include a cutting blade which is moved along the contour of the part to be cut.

Such cutting arrangements are known. They have generally a circular receiver for engaging a pin-or-finger-like blade shaft with a diameter of 8 mm or 6 mm.

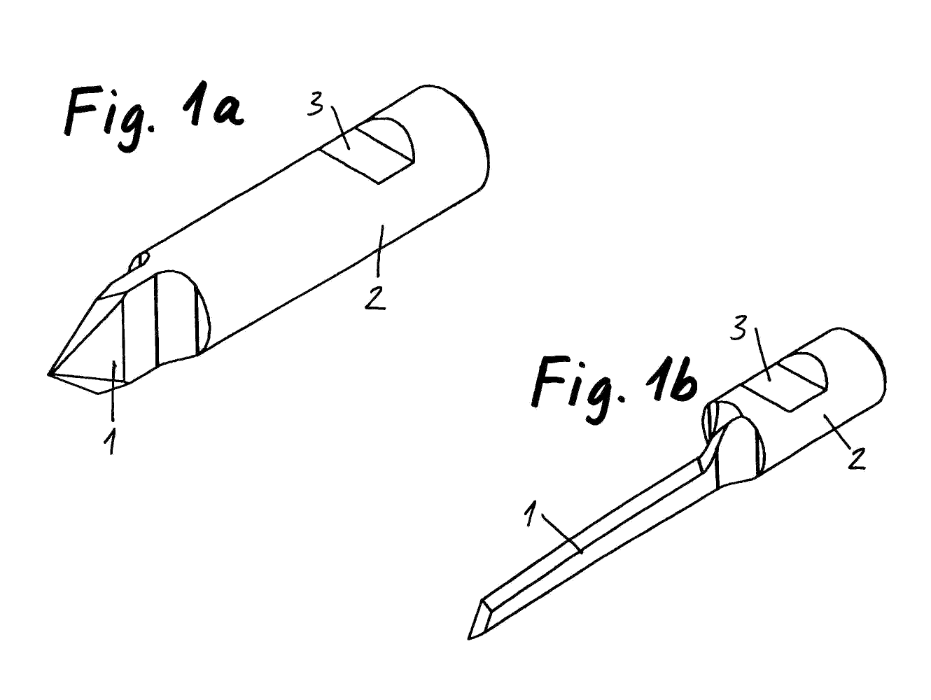

The cutting blades for such cutting arrangements consist of hard-metal in order to facilitate a fast and clean cutting with economical tool life for the cutting blades. FIGS. 1a and 1b are perspective views of two embodiments of such conventional cutting blades wherein FIG. 1a shows a larger cutting blade with a shaft diameter of 8 mm whereas FIG. 1b shows a smaller cutting blade with a shaft diameter of 6 mm. These conventional cutting blades are manufactured from a single piece: Using a rod-like hard-metal blank, a blade is formed at one end by cutting it from the rod-like blank. The remaining part of the rod-like blank forms the cylindrical shaft of the cutting blade, the length of which is over twice the length of the blade section. Into the rear part, a clamping surface 3 is ground which cooperates with a clamping screw of the cylindrical shaft receiver of the cutting arrangement.

Since hard metal is very expensive, these conventional cutting blades which, because of the precision required, are manufactured together with the cylindrical chucking shaft, as a single piece from a hard metal, are very expensive.

It is therefore the object of the present invention to provide a more expedient and less expensive cutting blade design.

### SUMMARY OF THE INVENTION

In the cutting blade arrangement according to the invention, the cutting blade itself consists of an elongated flat hard metal blank which is ground at the front end thereof so as to form the cutting blade and whose rear end area is accommodated, in an axial slot of the cylindrical chucking block. The blade is engaged and centered in the chucking block and is chucked in the cutting chuck together with the chucking block.

The cylindrical chucking block of the cutting blade arrangement may be manufactured from normal steel. The accommodation slot for receiving the rear part of the hard-metal cutting blade is preferably made by precision erosion. It replaces the cylindrical shaft part of the conventional hard-metal cutting blades made by cutting the blade from a rod-like hard metal blank.

The invention will become more readily apparent from the following description thereof on the basis of the accompanying drawings wherein:

FIGS. 1a and 1b show conventional cutting blades cut or ground from cylindrical blanks,

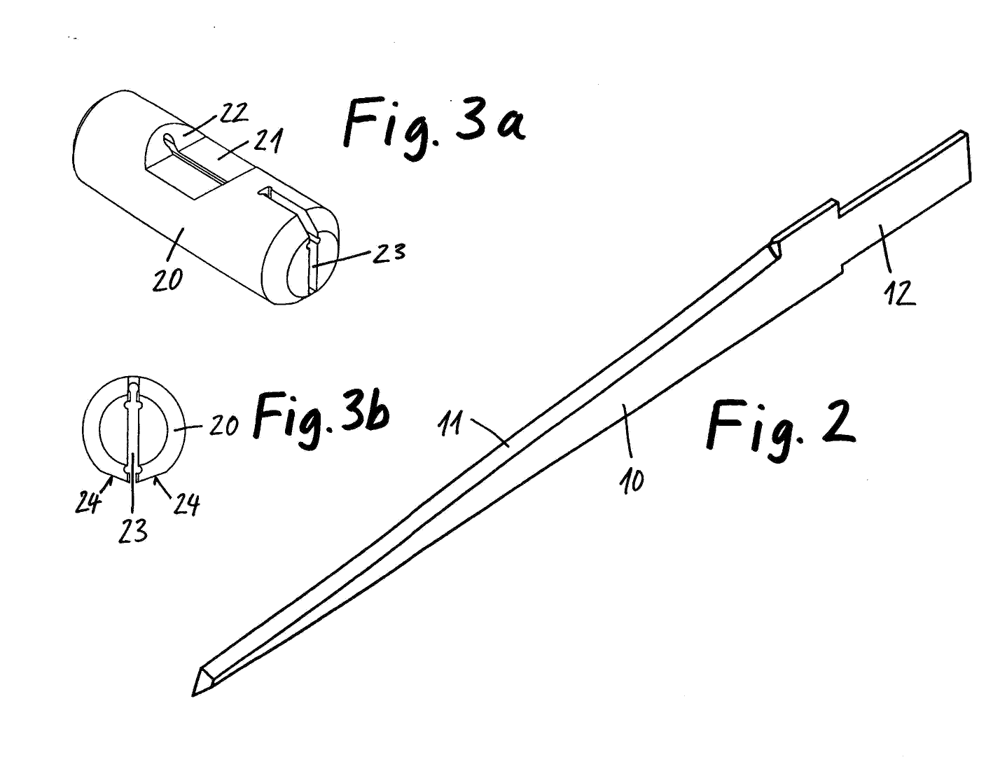

FIG. 2 is a perspective view of a cutting blade arrangement according to the invention,

FIG. 3a is a perspective view of the cylindrical receiver block for the cutting blade, and

FIG. 3b is a cross-sectional view of the receiver block of the cutting blade arrangement according to the invention.

### DETAILED DESCRIPTION OF THE CUTTING BLADE ARRANGEMENT

The cutting blade arrangement as shown in FIG. 2 consists of a hard metal blade 10 and is manufactured from a plate-shaped hard-metal blank, The cutting blade 10 has therefore the shape of a thin elongate plate body—as shown in FIG. 2 with a blade area 11 ground onto the front cutting area and a rear flat shaft area 12.

The cylindrical chucking block 20 as shown in FIGS. 3a and 3b consists for example of normal steel and has the shape of a cylindrical body fased at its axial ends and a planar area 21 ground into the cylindrical body so as to be delimited at both axial ends by inclined surface areas 22, with which it forms a recess with a fiat base area where the clamping screw of the cylindrical receiver engages the cylindrical body. The chucking block 20 further is provided with a central axial slot 23 which extends normal to the planar area 21 over the full azial length of the chucking block. The chucking block 20 is divided by this slot 23 as seen from the side facing the planar surface area 21 designated as “top” into two parallel halves disposed at opposite sides of the slot 23 which halves are joined at the “top” at opposite ends of the planar area 21 by small material webs which serve as kind of pivot joints so that the two halves of the chucking block can foe clamped together.

As shown in FIG. 3a, the axial slot 23 extends throughout the whole front area of the chucking block 20. The front area of the chucking block is the part into which the shaft 12 of the cutting blade 10 is inserted.

FIG. 3b is a cross-sectional view of the chucking block 20 shown in a perspective view in FIG. 3a. There, it is shown in detail that the slot is slightly narrowed in the front area and in the top area and in the lower area so that the shaft 12 of the cutting blade 10 cannot only be axially inserted into the slot 23 but is also fixed in the radial direction of the chucking block of the slot 23. The shaft 12 of the cutting blade 10 is—as shown in FIG. 2—smaller in its width (wherein “width” is the extension transverse to the plate thickness) than the largest width of the cutting blade with the exception of the front area thereof. The narrower area is consequently disposed completely within the slot 23 of the chucking block and the somewhat wider front area of the shaft is disposed in the front area of the slot 23 where the slot 23 extends over the full diameter of the chucking block. There, the wider front part of the shaft cooperates with the sections of reduced width forming a stop with the respective sections of the chucking body. The cutting blade can therefore be positioned in the chucking block 20 in a highly precise manner.

As the cross-sectional view of the chucking block 20 of FIG. 3b further shows, circumference of the chucking block, in the lower area thereof, that is opposite the upper planar area 21, is provided with inclined surface areas 24. The exact shape of the these inclined surface areas 24 is not important; it is only important that, upon insertion of the cylindrical chucking block 20 into a receiver chuck, its lower area does not abut the cylindrical internal surface of the receiver chuck of the cutting arrangement. As a result, when the clamping screw of the chuck of the cutting arrangement presses against the upper planar surface 21, a diametric pressure is exerted on the chucking block 20 with the shaft 12 of the cutting block 10 disposed therein so that the internal cylindrical surface, as a result of the inclinations in the lower area of the chucking block halves separated by the slot 23 are compressed, like by a cone, and the cutting blade shaft 12 is firmly engaged between the chucking block halves.

What is claimed is:

1. A hard metal cutting blade chucking arrangement for cutting parts from sheet materials, comprising: a cutting blade (10) of hard metal consisting of an elongate planar body with a front area having a cutting edge (11) ground thereon and a rear, plate-like shaft (12), and a cylindrical chucking block (20) provided with an axial slot (23) which extends diametrically over most of the diameter of the chucking block (20) and whose width corresponds to the plate width of the shaft (12) of the cutting blade (10), the cylindrical circumferential surface of the chucking block (20) being recessed radially inwardly along, and at opposite sides of, the ends of the slot (23).

2. The blade chucking arrangement according to claim 1, wherein opposite the open end of the axial slot (23) a planar surface area (21) is machined into the outer surface of the chucking block (20) so as to extend at a right angle to the axial slot (23) which surface area (21) forms an engagement area for a clamping screw for fixing the chucking block (20).

3. The blade chucking arrangement according to claim 2, wherein the axial slot (23) extends also through, the planar surface area (21).

4. The blade chucking arrangement according to claim 1, wherein the cylindrical circumferential surface of the chucking block (20) is provided along the open end of the longitudinal slot (23) with inclined areas (24) forming radial recesses (24) over the length of the chucking block (20).

5. The blade chucking arrangement according to claim 1, wherein at the front end of the chucking block (20) the longitudinal slot (23) extends over the full diameter of the chucking block (20) and forms at the transition to the remaining longitudinal slot an axial stop which cooperates with a corresponding step formed on the shaft (12) of the cutting blade (10).

6. The blade chucking arrangement according to claim 1, wherein the longitudinal slot (23) is formed by precision electro-erosion.

7. The blade chucking arrangement according to claim 6, wherein, in the area of the ends of the chucking block (20) area through which the longitudinal slot (23) extends, the longitudinal slot (23) is somewhat narrowed to the extent that the width of the slot in the narrowed areas corresponds to the dimensions of the shaft (12) of the cutting blade (10).

8. The blade chucking arrangement according to claim 7, wherein in an axial front area of the longitudinal slot (23) where the slot (23) extends over the whole diameter of the chucking block (20) no narrowing of the slot is provided.
